(19) United States
(12) Patent Application Publication
(10) Pub. No.: US 2020/0021647 A1
(43) Pub. Date: Jan. 16, 2020

(54) Method of P2P Botnet Detection Based on Netflow Sessions

(71) Applicant: National Cheng Kung University, Tainan (TW)

(72) Inventors: Ce-Kuen Shieh, Hsinchu (TW); Jyh-Biau Chang, Tainan (TW); Chun-Yu Wang, Kaohsiung (TW); Chi-Lung Ou, New Taipei City (TW)

(21) Appl. No.: 16/035,874

(22) Filed: Jul. 16, 2018

(51) Int. Cl. H04L 29/08; H04L 29/06

(52) U.S. Cl. CPC H04L 67/1044; H04L 67/14; H04L 69/16

(57) ABSTRACT

The present invention detects bidirectional sessions of flows for finding P2P botnets. Unidirectional flows are combined to obtain the bidirectional sessions. The present invention is a method based on Netflow. The purpose is to highlight bidirectional sessions in a unidirectional Netflow log for determining malware activities. In addition, the present invention uses megadata for development and is implemented on MapReduce platform. Through a novel multi-layer unsupervised grouping algorithm for exploring similar bidirectional sessions, activities of the P2P botnet are analyzed. The novel grouping algorithm is coordinated with density-based clustering process to repeatedly analyze the Netflow log. Each algorithm layer extracts out a group and, in the end, collections with similar malicious behaviors are clustered out. At last, an actual Netflow log is used to prove that the present invention has a reliability up to 95%. Thus, the present invention can effectively strengthen national security information.

### TECHNICAL FIELD OF THE INVENTION

The present invention relates to detecting peer-to-peer (P2P) botnets; more particularly, to an unsupervised algorithm of finding out a lot of flows having similar behaviors for marking out known or unknown botnets.

### DESCRIPTION OF THE RELATED ARTS

Existing related prior arts for finding botnets mostly focus on pre-defined rules. Warning will be issued only if the rules are met. Unknown malwares are not marked out and filtered. For example, a prior art provides a method of identifying P2P botnet by using a statistical analysis of small flows. This prior art analyzes Neflow log to classify network flows into in-flow sets and out-flow sets. Sliding-window is used as a base to determine similar behaviors of botnets. However, thresholds are required and pre-defined for determining botnet activity. The threshold might be various for each botnet. Furthermore, a technical process of combined sessions for determining similarity is not revealed. U.S. Pat. No. 8,762,298 B1 is ‘Machine learning based botnet detection using real-time connectivity graph based traffic features’, which mainly detects command and control (C&C) botnets. In a graph-based way, whether any IP communicates with C&C servers or not is determined. However, this prior art requires the help of historical information to accurately determine whether any malicious behavior occurs or not. U.S. Patent 20170251005 A1 is ‘Techniques for botnet detection and member identification’, which is a method for determining whether a host communicates with botnet member or not. Botnet members are recorded in a historical data table. If a host communicates with more than one botnet member, it is suspicious about malicious behavior. Another prior art provides a method of detecting malicious behaviors bases on credibility for a network having high-volume flows. This prior art is an online method of detecting malicious behaviors. Netflow features are directly used to calculate the p-value with a known malicious behavior matrix. If the p-value lies within a certain range, the host most likely behaves maliciously. Another prior art provides a method of detecting botnet based on Netflow and DNS log. Through a monitoring technology of abnormal flows, collected Netflow data are quickly processed through correlational analysis. Yet, this prior art has a disadvantage of further using the DNS log after using the Netflow log. Another prior art provides a method of detecting abnormal flows. A fixed sliding-window is used for online detection. Under a certain trigger condition, abnormal flows are detected. Yet, the prior art has a disadvantage of defining detection condition in advance but not finding the flows having similar behaviors, since a large number of behavior patterns of the same kind are most likely caused by botnet activities. Another prior art provides a method, a device and a processor for detecting botnet. An average total of packet bytes and an average total of bytes per second are calculated as communication features. Grouping rules are preset for clustering. Yet, the prior art has disadvantages of not using the features retrieved from the Netflow log, the behavior features of botnet viruses, and the setting of grouping thresholds, for detecting botnet.

From the above prior arts, it is known that current methods for botnet detection mostly use features of flows directly for finding similarity without combining flows into sessions in advance. Therefore, current researches are all based on experimental data as well as ISCX, CTU13 etc. There are few relative studies on P2P botnet analysis with actual mass flows. Another prior art provides a method of cooperating detection of botnet based on FedMR. But, the step of Ranking and Association is hard to practice in a cooperating way. It does not provide complete processes. Hence, the prior arts do not fulfill all users' requests on actual use.

### SUMMARY OF THE INVENTION

The main purpose of the present invention is to provide a method of building session information to analyze botnet behaviors for detecting P2P botnets on Netflow.

Another purpose of the present invention is to use megadata for development to be implemented on MapReduce platform, where the present invention is verified to withstand a level of Netflow log up to 1 tera-bytes with real data.

Another purpose of the present invention is to provide a complete two-month log of actual network flows of a university for test along with a real blacklist for validation, where the present invention proves that its reliability is higher than 95% for effectively strengthening the protection of nation information security.

To achieve the above purposes, the present invention is a method of detecting P2P botnet based on Netflow sessions, comprising steps of session extraction, filtering, grouping, and reverse lookup, where a Netflow log is inputted; each record in the log is a unidirectional flow; data inputted from said log comprises a timestamp, a source IP (Src IP, IP=Internet Protocol address), a destination IP (Dst IP), a port number and a packet total; a time-interval threshold is used to be a standard to combine the unidirectional flows into bidirectional sessions; a flow and another flow followed adjacently in a communication between two IPs are defined as in the same period and combined into a session when a time interval between the two flows does not exceed the time-interval threshold; features of the two flows of the session are combined and computed to obtain a plurality of the features highlighting communication behaviors; feature ranking is processed with the features of the session to obtain outstanding ones of the features through information gain to obtain a feature vector (FV) of the session to process subsequent detection; the filtering comprises two sub-steps, including whitelist filtering and flow loss-response filtering; a whitelist and a loss rate are used to be standards to filter out normal flows and non-P2P communication-behavior flows; the grouping comprises three levels of grouping, including a first level of SuperSession grouping, a second level of SessionGroup grouping and a third level of BehaviorGroup grouping; a group of IPs are defined as carrying suspicious virus of P2P botnet according to virus behaviors of P2P botnet along with a distance threshold and a group total threshold; and a blacklist is used to directly and indirectly process verification to obtain a suspicious IP list through reverse lookup. Accordingly, a novel method of detecting P2P botnet on Netflow is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the process-flow view showing the preferred embodiment according to the present invention;

FIG. 2 is the view showing the pseudo code of whitelist filtering;

FIG. 3 is the view showing the first part of the pseudo code of flow loss-response (FLR) filtering;

FIG. 4 is the view showing the second part of the pseudo code of FLR filtering;

FIG. 5 is the view showing the third part of the pseudo code of FLR filtering;

FIG. 6 is the view showing the first level of SuperSession grouping;

FIG. 7 is the view showing the pseudo code of the first level of grouping;

FIG. 8 is the view showing the second level of SessionGroup grouping;

FIG. 9 is the view showing the pseudo code of the second level of grouping;

FIG. 10 is the view showing the third level of BehaviorGroup grouping; and

FIG. 11 is the view showing the pseudo code of the third level of grouping.

### DESCRIPTION OF THE PREFERRED EMBODIMENT

The following description of the preferred embodiment is provided to understand the features and the structures of the present invention.

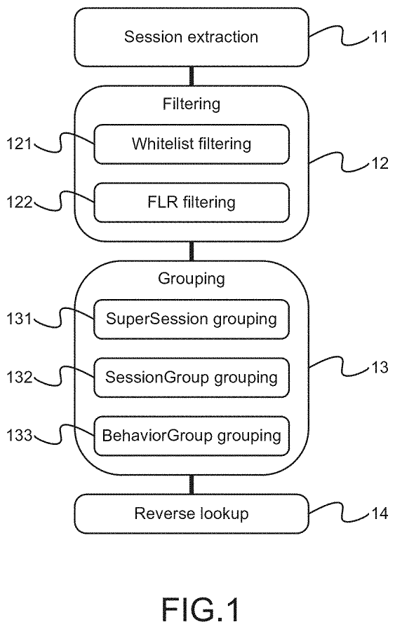

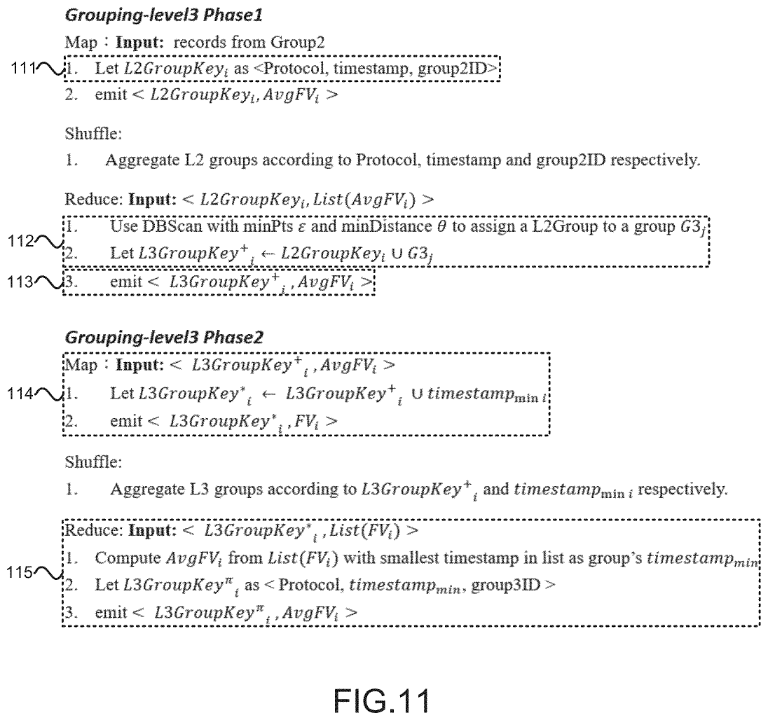

Please refer to FIG. 1˜FIG. 11, which are a process-flow view showing a preferred embodiment according to the present invention; a view showing a pseudo code of whitelist filtering; a view showing a first, a second and a third part of a pseudo code of flow loss-response (FLR) filtering; a view showing a first level of SuperSession grouping; a view showing a pseudo code of the first level of grouping; a view showing a second level of SessionGroup grouping; a view showing a pseudo code of a second level of grouping; a view showing a third level of BehaviorGroup grouping; and a view showing a pseudo code of the third level of grouping. As shown in the figures, the present invention is a method of detecting peer-to-peer (P2P) botnet based on Netflow sessions, where bidirectional sessions are built through combining unidirectional network flows; unidirectional flows are processed to highlight communication features for determining malware activity behaviors; and a P2P botnet detection system based on finding similar behaviors in communications is thus constructed on a MapReduce platform (such as Hadoop) by following the design concept of unsupervised algorithm. In FIG. 1, a flow view for a Netflow log is shown according to the present invention, comprising four steps:

(a) Session extraction [11]: Unidirectional Netflow data are combined into bidirectional data according to source IP (Src IP, IP=internet protocol address), destination IP (Dst IP), port number and time-interval threshold for highlighting communication features between IPs.

(b) Filtering [12]: Two sub-steps, whitelist filtering [121] and flow loss-response (FLR) filtering [122], are included. A whitelist and a loss rate are used as standards for filtering out normal flows and flows of non-P2P communication behaviors.

(c) Grouping [13]: The grouping [13] comprises three levels of grouping, including a first level of SuperSession grouping [131], a second level of SessionGroup grouping [132] and a third level of BehaviorGroup grouping [133]. A group of IPs are defined as IPs carrying suspicious virus of P2P botnet based on virus behaviors of P2P botnet, a distance threshold and a group total threshold.

(d) Reverse lookup [14]: A blacklist is used to directly and indirectly process verification for obtaining a suspicious IP list through reverse lookup.

Thus, a novel method of detecting P2P botnet based on Netflow sessions is obtained.

The above steps are processed step by step for detecting botnet. The following are details and data formats.

In step (a), the Netflow log is inputted where each record in the log is a unidirectional flow ; and data inputted from the log comprises a timestamp, a Src IP, a Dst IP, a port number and a packet total. However, the unidirectional flows do not highlight communication features. Therefore, in step (a) Session extraction [11], a time-interval threshold is used as a standard for combining the unidirectional flows into bidirectional sessions. The time-interval threshold comprises a Transmission Control Protocol (TCP) sub-threshold of 22 seconds (sec); and a User Datagram Protocol (UDP) sub-threshold of 21sec. When a time interval between a flow and another flow followed adjacently in a communication between two IPs does not exceed the time-interval threshold, the two flows are defined as in the same period and combined into a session. Features of the two flows of the session are combined and computed to obtain the features highlighting communication behaviors of the session. The features of the session are processed through feature ranking with information gain to obtain outstanding features of the session. The following Table 1 shows a table of a feature vector (FV). The present invention processes ranking to 20 features, where 14 features (*) are selected to form the FV of the session for subsequent detections. The total of the features selected is flexible and any combination of features is available for the subsequent detections.

TABLE 1

| Direction | Feature | Sequence | Description |
|---|---|---|---|
| Forward | Forward_Pkts* | 1.05765 | Packet total from |
| | | | Src IP to Dst IP |
| | Forward_Bytes* | 1.17954 | Byte total from |
| | | | Src IP to Dst IP |
| | Forward_MaxBytes* | 1.00955 | Byte maximum from |
| | | | Src IP to Dst IP |
| | Forward_MinBytes* | 1.01777 | Byte minimum from |
| | | | Src IP to Dst IP |
| | Forward_MeanByte* | 1.02147 | Byte mean from |
| | | | Src IP to Dst IP |
| Backward | Backward_Pkts | 0.82696 | Packet total from Dst |
| | | | IP to Src IP |
| | Backward_Bytes* | 0.99065 | Byte total from Dst |
| | | | IP to Src IP |
| | Backward_MaxBytes* | 1.02112 | Byte maximum from |
| | | | Dst IP to Src IP |
| | Backward_MinBytes* | 1.0214 | Byte minimum from |
| | | | Dst IP to Src IP |
| | Backward_MeanByte* | 1.02112 | Byte mean from |
| | | | Dst IP to Src IP |
| Total | Total_Pkts | 0.91196 | Packet total of |
| | | | bidirectional data |
| | Total_Bytes* | 1.02132 | Byte total of |
| | | | bidirectional data |
| | Total_MaxBytes* | 1.02127 | Byte maximum of |
| | | | bidirectional data |
| | Total_MinBytes | 0.91188 | Byte minimum of |
| | | | bidirectional data |
| | Total_MeanByte* | 1.08504 | Byte mean of |
| | | | bidirectional data |
| | Total_STDByte* | 1.06214 | Standard deviation |
| | | | of bytes of |
| | | | bidirectional data |
| | Total_ByteRate | 0.77111 | Byte speed of |
| | | | bidirectional data |
| | Total_PacketRate | 0.6363 | Packet speed of |
| | | | bidirectional data |
| | Total_IORatio* | 1.13313 | Transmission rate of |
| | | | bidirectional data |
| | | | Rate of byte totals of |
| | | | bidirectional data |
| | Total_Duration | 0.65722 | Total bidirectional |
| | | | duration |

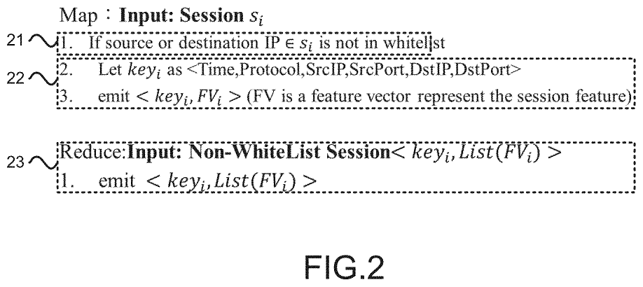

Therein, the present invention calculates the total of in-flows and out-flows to define a rate of FLRs of the sessions for determining P2P communication behaviors. In step (b) Filtering [12], two sub-steps are processed. At first, the sub-step of whitelist filtering [121] processes filtering with a whitelist to delete the sessions of known benign IPs, such as domain name system servers (DNS Server) or well-known web sites. Then, the sub-step of FLR filtering [122] filters the sessions of communication behaviors not having P2P features. A pseudo code of the two sub-steps for MapReduce platform is shown in FIG. 2.

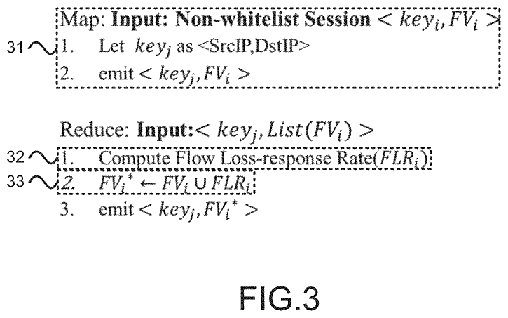

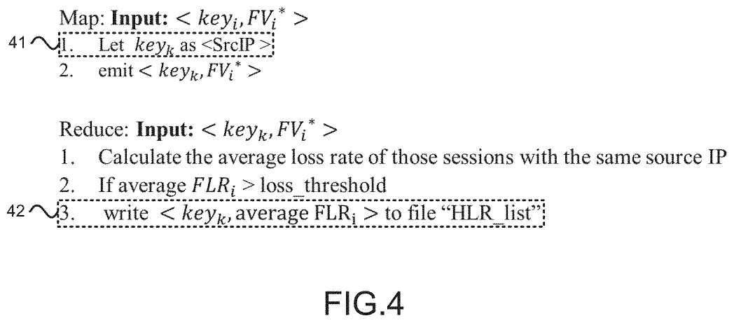

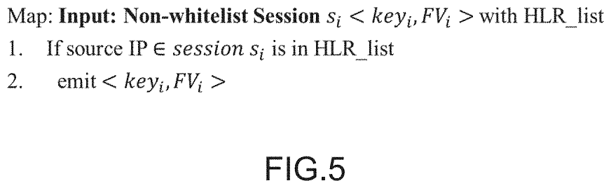

The pseudo code of the sub-step of whitelist filtering [121] is shown in FIG. 2. Therein, the Src IPs and the Dst IPs of the sessions are checked. Any one of the sessions having the Src IP or the Dst IP existed in the whitelist are deleted and the remaining ones of the sessions are defined as suspicious sessions [21]. A reduce key consisting of <time, srcIP(=Src IP), srcPort(=source port), dstIP(=Dst IP), dstPort(=destination port)> is generated and sent to a reduce function as the FV of the session [22]. The Reduce section [23] is an identity function. Then, the sub-step of FLR filtering [122] which comprises three stages is processed, as shown in FIG. 3, FIG. 4 and FIG. 5. The first stage calculates a total of FLRs. The second stage calculates an average FLR of the same Src IP. The third stage records the sessions having high FLRs into a list to be used to filter non-P2P flows.

A first part of the pseudo code of the sub-step of FLR filtering [122] is shown in FIG. 3. In FIG. 3, the Map section [31] is a unit function, which outputs a key of the Src IP and the Dst IP. In the Reduce section, the present invention calculates the average FLR of the sessions having the same IP pair to be labelled as the FLR of the IP pair [32]. The present invention uses the FLR as a new feature to be merged into the current FV of the session [33]. The input data and the output data are not different except the FLR added.

A second part of the pseudo code of the sub-step of FLR filtering [122] is shown in FIG. 4. In FIG. 4, the Map section is still a unit function, which outputs a key of the Src IP of the session [41]. In the Reduce section, the FLRs of the same Src IP are calculated to obtain the average FLR. If the average FLR is greater than a threshold (0.225 in default), then the Src IP is written into a list of IPs having high FLR (HLR) [42].

A third part of the pseudo code of the sub-step of FLR filtering [122] is shown in FIG. 5. In FIG. 5, the result of the Session extraction [11] is compared with the list of IPs having HLR. The Src IP existed in the list will be outputted to be clustered in step (c).

The present invention processes the three levels of grouping in step (c) Grouping [13] by using the following features of P2P botnet: (1) the repeating connections with peers; (2) the connections with other peers; and (3) similar communication behaviors between P2P botnets. To obtain similar communication behaviors, a formula of Euclidean distance is used to calculate a distance between the FVs of two of the sessions. In fact, any formula of space measurement for calculating a distance between two data dimensions is available. The three levels of grouping are processed based on a total of the sessions having similar communication behaviors with the distances exceeding a distance threshold (which is 3 in default).

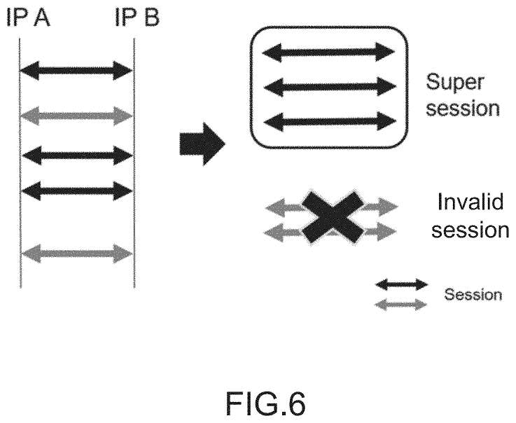

As described above, in the first level of SuperSession grouping [131] in step (c) Grouping [13], the repeating communications with peers as a feature of P2P botnet is used for grouping. In FIG. 6, a plurality of the sessions are existed in IP A and IP B. The sessions are clustered with a similarity-judging formula to obtain SuperSessions consisting of similar sessions. The average FV of the similar sessions is calculated to be an FV of each SuperSession. Then, the second level of SessionGroup grouping [132] is processed.

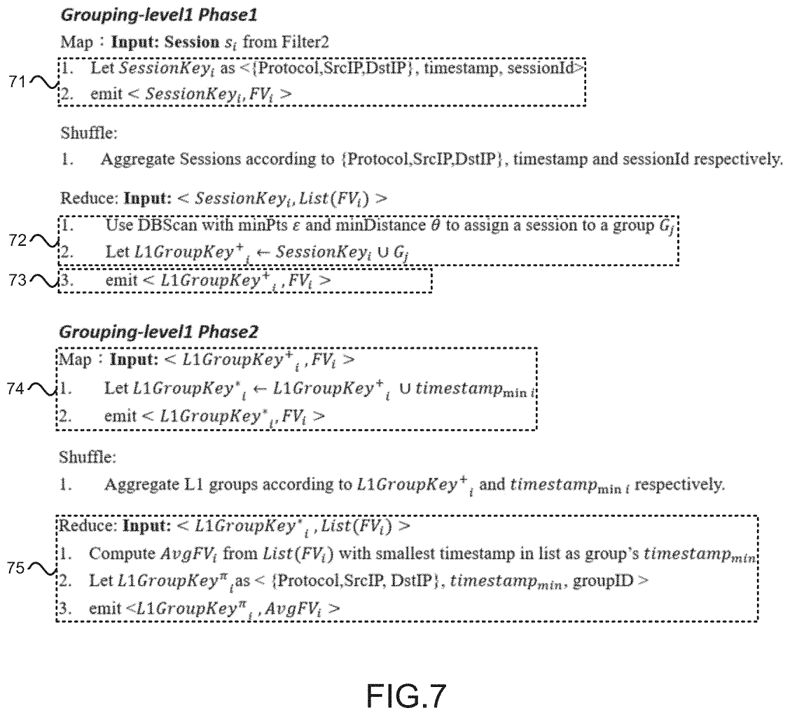

The pseudo code of the first level of grouping of step (c) Grouping [13] is shown in FIG. 7. There are two phases. In the first phase, the Map section [71] generates a key consisting of protocol, Src IP and Dst IP. Then, a similarity judgement is processed with a Euclidean distance in the Reduce section [72]. The result of grouping is combined into a key to be passed into the second phase [73]. In the second phase, the Map section [74] adds a minimum timestamp to the original key. Then, the Reduce section [75] calculates an average FV to represent the FV of a SuperSession of the sessions clustered.

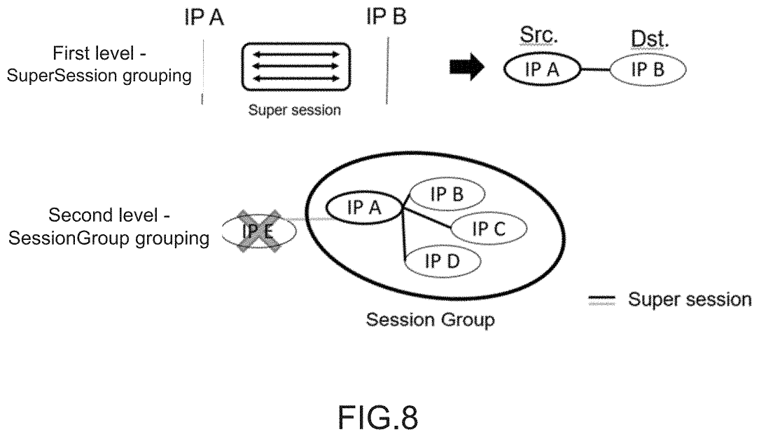

In the second level of SessionGroup grouping [132] in step (c) Grouping [13], the communications with other peers as a feature of P2P botnet is used for grouping. In FIG. 8, IP A obtains a plurality of SuperSessions after the first level of grouping. The SuperSessions of IP A are also processed with a similarity-judging formula. SessionGroups each consisting of similar SuperSessions are clustered out. Each average FV of the similar SuperSessions is calculated as an FV of each SessionGroup. Then, the second level of BehaviorGroup grouping [133] is processed.

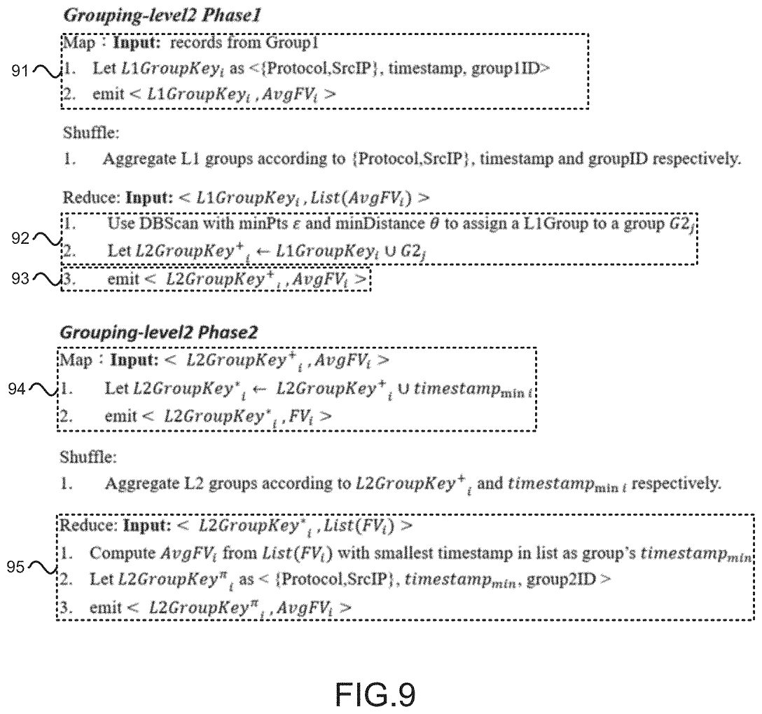

The pseudo code of the second level of grouping of step (c) Grouping [13] is shown in FIG. 9. In this level, there are two phases. The first phase differs from that of the first level in the following: The Map section [91] generates a key consisting of protocol and Src IP. Then, a similarity judgement is also processed in the Reduce section [92]. The result of grouping is combined into a key to be passed into the second phase [93]. In the second phase, the Map section [94] adds a minimum timestamp to the original key. Then, the Reduce section [95] calculates an average FV to represent the FV of a SessionGroup of the SuperSessions clustered.

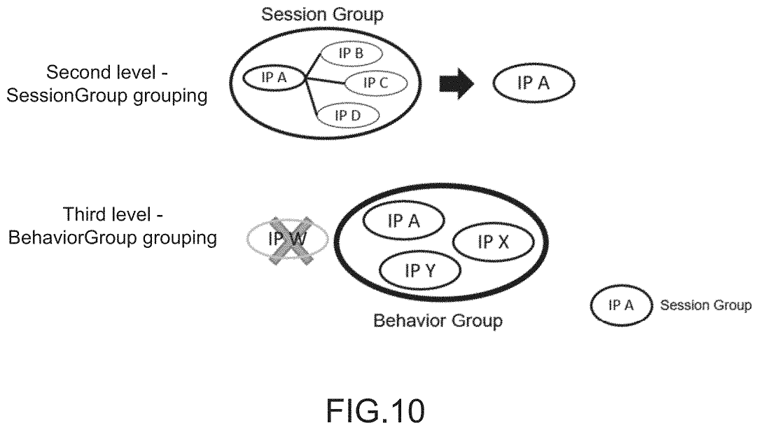

At last, in the third level of BehaviorGroup grouping [133] in step (c) Grouping [13], the feature of similar communication behaviors between P2P botnets is used for grouping. In FIG. 10, SessionGroups like IP A are formed after the second level of grouping. The SessionGroups (e.g. IP A, IP X, IP Y and IP W in FIG. 10) are clustered with a similarity-judging formula to obtain BehaviorGroups consisting of similar SessionGroups. Each average FV of the similar SessionGroups is calculated as an FV of each BehaviorGroup.

The pseudo code of the third level of grouping of step (c) Grouping [13] is shown in FIG. 11. In this level, there are two phases too. The Map section in the first phase generates a key consisting of protocol, timestamp and group ID(=identification code) [111]. Then, a similarity judgement is also processed in the Reduce section [112]. The result of grouping is combined into a key to be passed into the second phase [113]. In the second phase, the Map section [114] also adds a minimum timestamp to the original key. Then, the Reduce section [115] calculates an average FV to represent the FV of a BehaviorGroup of the SessionGroups clustered.

The mode of operation is described above according to the present invention. The following is an experiment for the feasibility of the present invention by using an actual Netflow log. the present invention processes verification with the coordination of the VirusTotal service to directly and indirectly determine whether the IPs selected out are suspicious IPs or not. The present invention uses a 61-day Netflow log of a university (a total of 242 giga-bytes (GB) for 930915 IPs) inputted in a base of per-week records as a unit for detection. The FLR has to be higher than 0.225 and the distance threshold is set to be 2. The grouping [13] clusters and updates representative FVs only when a total of items in a clustered group is more than 3. The Netflow log and the detection parameters are shown in Table 2 as follows:

TABLE 2

| Source | A university |
|---|---|
| Duration | 61 days |
| Size | 242 GB, |
| | IP total: 930915 |
| Unit | Every 7 days |
| | for detection and analysis |
| FLR | 0.225 |
| Distance formula | Euclidean distance |
| Distance threshold | 2 |
| Grouping 1 threshold | 3 |
| Grouping 2 threshold | 3 |
| Grouping 3 threshold | 3 |
| Verification threshold | 5 |

For verification, the BehaviorGroups generated after the third level of grouping are directly verified with their Src IPs by using the blacklist (from VirusTotal, but not limited). If more than five ones of the Src IP in the BehaviorGroups are existed in VirusTotal, all IPs in the entire BehaviorGroups are regarded as suspicious IPs behaving maliciously. After the three levels of grouping, the clustered groups have similar FVs. It means that, although the behaviors of some IPs do not make them included in the VirusTotal blacklist, these IPs behave the same as malicious IPs. Therefore, they are still regarded as IPs behaving maliciously. The data set obtained after the above processes of filtering and grouping is verified directly and indirectly; and the result, including per-week data size, IP total, etc., is shown in Table 3. Detected IP Total is the total of IPs in all the BehaviorGroups after removing the repeated ones; Directed IP Total is the total of IPs directly existed in VirusTotal; and Verified IP Total is the total of IPs in all the BehaviorGroups determined as behaving maliciously after removing the repeated ones. As seen in the result, the precisions are all above 90 percent, which proves the effectiveness of detection according to the present invention.

TABLE 3

| Time | | | Detected | Directed | Verified | |
|---|---|---|---|---|---|---|
| period | Size | IPs | IP Total | IP Total | IP Total | Precision |
| The 1st | 33G | 354576 | 10214 | 1049 | 9969 | 97.60% |
| week | | | | | | |
| The 2nd | 31G | 297243 | 11131 | 1144 | 10735 | 96.44% |
| week | | | | | | |
| The 3rd | 33G | 266545 | 10900 | 1055 | 10526 | 96.57% |
| week | | | | | | |
| The 4th | 28G | 234223 | 8772 | 951 | 8401 | 95.77% |
| week | | | | | | |
| The 5th | 23G | 159216 | 5709 | 770 | 5389 | 94.39% |
| week | | | | | | |
| The 6th | 25G | 149563 | 5383 | 718 | 5019 | 93.24% |
| week | | | | | | |
| The 7th | 23G | 140810 | 4791 | 628 | 4346 | 90.71% |
| week | | | | | | |
| The 8th | 21G | 141374 | 4958 | 662 | 4634 | 93.47% |
| week | | | | | | |
| The 10th | 25G | 110563 | 3600 | 474 | 3333 | 92.58% |
| week | | | | | | |

Currently, every nation regards information security as an important national security issue. The present invention provides a method for detecting P2P botnet on Netflows with an unsupervised algorithm. The unsupervised algorithm is based on Netflow. Session information is built by analyzing botnet behaviors to find a lot of flows having similar behaviors. Thus, known or unknown botnets can be marked out. The present invention uses megadata for development and is implemented on MapReduce platform. The whole process is more complete than existing prior arts. A complete two-month log is provided for experiment. By the result, the present invention is actually verified to withstand a level of Netflow log up to 1 tera-bytes. The log of actual flows of a university is provided for experiment along with a real blacklist for validation. Accordingly, the present invention proves that its reliability (more than 95%) is higher than the other prior arts for effectively strengthening the protection of nation information security.

To sum up, the present invention is a method of detecting P2P botnet based on Netflow sessions, where an unsupervised algorithm based on Netflow is used to build session information by analyzing botnet behaviors for finding a lot of flows having similar behaviors; known or unknown botnets can be marked out; and the present invention proves that its reliability (more than 95%) is higher than the other prior arts for effectively strengthening the protection of nation information security.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of detecting P2P botnet based on Netflow sessions, comprising steps of:
(a) session extraction,
wherein a Netflow log is inputted; each record in said log is a unidirectional flow; and data inputted from said log comprises a timestamp, a source IP (Src IP, IP=Internet Protocol address), a destination IP (Dst IP), a port number and a packet total; and
wherein a time-interval threshold is used to be a standard to combine said unidirectional flows into bidirectional sessions; a flow and another flow followed adjacently in a communication between two IPs are defined as in the same period and combined into a session when a time interval between said two flows does not exceed said time-interval threshold; features of said two flows of said session are combined and computed to obtain a plurality of said features highlighting communication behaviors; feature ranking is processed with said features of said session to obtain outstanding ones of said features through information gain to obtain a feature vector (FV) of said session to process subsequent detection;
(b) filtering,
wherein said filtering comprises two sub-steps, including whitelist filtering and flow loss-response (FLR) filtering; and a whitelist and a loss rate are used to be standards to filter out normal flows and non-P2P communication-behavior flows;
(c) grouping,
wherein said grouping comprises three levels of grouping, including a first level of SuperSession grouping, a second level of SessionGroup grouping and a third level of BehaviorGroup grouping; and a group of IPs is defined as carrying suspicious virus of P2P botnet according to virus behaviors of P2P botnet along with a distance threshold and a group total threshold; and
(d) reverse lookup,
wherein a blacklist is used to directly and indirectly process verification to obtain a suspicious IP list through reverse lookup.

2. The method according to claim 1,
wherein said time-interval threshold comprises a Transmission Control Protocol (TCP) sub-threshold of 22 seconds (sec); and a User Datagram Protocol (UDP) sub-threshold of 21 sec.

3. The method according to claim 1,
wherein said session extraction obtains 14 ones from said features of a session; and
wherein said 14 features comprises Forward_Pkts, Forward_Bytes, Forward_MaxBytes, Forward_MinBytes, Forward_MeanByte, Backward Bytes, Backward_MaxBytes, Backward_MinBytes, Backward_MeanByte, Total_Bytes, Total_MaxBytes, Total_MeanByte, Total_STDByte and Total_IORatio to respectively represent a packet total between said Src IP and said Dst IP, a byte total from said Src IP to said Dst IP, a byte maximum from said Src IP to said Dst IP, a byte minimum from said Src IP to said Dst IP, a byte mean from said Src IP to said Dst IP, a byte total from said Dst IP to said Src IP, a byte maximum from said Dst IP to said Src IP, a byte minimum from said Dst IP to said Src IP, a byte mean from said Dst IP to said Src IP, a byte total of bidirectional data between said Src IP and said Dst IP, a byte maximum of bidirectional data between said Src IP and said Dst IP, a byte mean of bidirectional data between said Src IP and said Dst IP, a standard deviation of bytes of bidirectional data between said Src IP and said Dst IP, and a transmission rate of bidirectional data between said Src IP and said Dst IP (i.e. a rate of said byte totals of bidirectional data between said Src IP and said Dst IP).

4. The method according to claim 3,
wherein said features are changeable and omit-able.

5. The method according to claim 1,
wherein, in step (b), said sub-step of whitelist filtering processes filtering with a whitelist to delete said sessions of known benign IPs; and said sub-step of FLR filtering filters said sessions of communication behaviors not having P2P features.

6. The method according to claim 1,
wherein said sub-step of whitelist filtering checks Src IPs and Dst IPs of said sessions; and any one of said sessions having an IP selected from a group consisting of said Src IP and said Dst IP existed in said whitelist are deleted and the remaining ones of said sessions are defined as suspicious sessions.

7. The method according to claim 1,
wherein said sub-step of FLR filtering comprises three stages: a first stage, a second stage and a third stage; said first stage calculates a total of FLRs; said second stage calculates a rate of FLRs of the same Src IP; and said third stage records said sessions having high FLRs into a list to be used to filter non-P2P flows.

8. The method according to claim 1,
wherein, in step (c), said grouping comprises three levels of grouping based on features of P2P botnet; and said levels of grouping process a multi-layer algorithm to cluster said sessions having the same communication behaviors.

9. The method according to claim 1,
wherein, in step (c), said grouping uses density-based grouping algorithms.

10. The method according to claim 1,
wherein, in step (c), said grouping comprises three levels of grouping to be processed with a base of features of P2P botnet; to determine similar communication behaviors, a space-measuring formula calculating a data-dimensional distance between two data is used; and
wherein, by using said space-measuring formula, a plurality of groups having similar communication behaviors are clustered out of said sessions having said data-dimensional distance exceeding said distance threshold; and the total of items in each one of said groups exceeds said group total threshold.

11. The method according to claim 10,
wherein said space-measuring formula is a formula of Euclidean distance and said data-dimensional distance between two data is an FV distance between two clustered groups of said sessions.

12. The method according to claim 10,
wherein said group total threshold is a number selected from a group consisting of a number more than 3 and a scale-based number.

13. The method according to claim 1,
wherein, in step (c), said first level of SuperSession grouping uses the feature of repeating communications toward peers; said sessions are clustered with a similarity-judging formula to obtain SuperSessions consisting of similar ones of said session; and each average FV of said similar ones of said session is calculated to be an FV of each one of said SuperSessions.

14. The method according to claim 1,
wherein, in step (c), said second level of SessionGroup grouping uses a feature of repeating communications toward other peers; a plurality of SuperSessions obtained after said first level of SuperSession grouping are clustered with a similarity-judging formula to obtain SessionGroups consisting of similar ones of said SuperSession; and each average FV of said similar ones of said SuperSession is calculated to be an FV of each one of said SessionGroups.

15. The method according to claim 1,
wherein, in step (c), said third level of BehaviorGroup grouping uses a feature of similar communication behavior between P2P botnets; a plurality of said SessionGroups obtained after said second level of SessionGroup grouping are clustered with a similarity-judging formula to obtain BehaviorGroups consisting of similar ones of said SessionGroup; and each average FV of said similar ones of said SessionGroup is calculated to be an FV of each one of said BehaviorGroups.
